(19) United States
(12) Patent Application Publication
(10) Pub. No.: US 2024/0389202 A1
(43) Pub. Date: Nov. 21, 2024

(54) Heatable Sensor Cover

(71) Applicant: SICK AG, Waldkirch (DE)

(72) Inventors: Thomas RUSS, Denzlingen (DE); Florian LEMKE, Freiburg (DE)

(21) Appl. No.: 18/666,073

(22) Filed: May 16, 2024

(30) Foreign Application Priority Data
May 17, 2023 (DE) 102023113026.9

(51) Int. Cl. H05B 3/84

(52) U.S. Cl. CPC H05B 3/84

(57) ABSTRACT

A heatable cover for an optical sensor comprises a transparent cover element, a transparent and electrically conductive coating that is arranged at the cover element, and at least two electrodes that are spaced apart from one another and that are each in contact with the conductive coating. A respective distance between a respective two of the electrodes is defined along a respective distance line across the coating. Each of the at least two electrodes further has at least one contacting position at which the respective electrode is connected to a voltage source. The contacting positions of a respective two electrodes are spaced apart from one another in a direction that extends at a right angle to the distance line.

The invention relates to a heatable cover for an optical sensor.

Optical sensors, which are, for example, laser scanners, are often protected against environmental influences by a transparent cover. Such a cover is typically cylindrical. However, the environmental conditions under which the optical sensors are used can lead to moisture or even ice forming on the surface of the cover. The transparency of the cover can thereby be limited and scattered radiation can occur due to moisture and/or ice on the cover. The overall performance of the optical sensors can thereby be limited due to the environmental conditions, in particular at low temperatures.

To prevent moisture and ice from being deposited at the surface of optical sensors, the covers of the optical sensors can be provided with a heating. In the case of optical sensors with a planar cover, such a heating is often realized by heating coils that are arranged at the inner side of a cover such that they surround an optical inlet opening and outlet opening of the respective optical sensor. The heating coils can, for example, be vapor-deposited onto the cover or glued to the cover using a carrier film.

However, covers of optical sensors are often made of plastic. Compared to glass, such a plastic has a significantly poorer thermal conductivity and a considerably higher coefficient of thermal expansion. With a cover composed of plastic, the use of heating coils can therefore lead to an inhomogeneous heating and/or an overall heating function that is not sufficient for removing moisture and ice from the cover.

Furthermore, changes to the optical properties of the cover can occur when heating coils are used.

If the optical sensor is a scanner, the required surface portion for the optical opening in relation to the total surface of the cover is usually significantly larger than with many static optical sensors that often do not have a scanning function. Since, with a scanning optical sensor, the surface area that is available for heating coils is thus considerably restricted, a use of heating coils with scanning optical sensors would inevitably lead to an inefficient heating of the cover.

An object of the invention is to provide a cover for an optical sensor that is homogeneously and sufficiently heatable over a region of an optical opening of the sensor.

This object is satisfied by a heatable cover having the features of claim 1. Advantageous further developments of the invention are set forth in the dependent claims, in the description, and in the drawings.

The heatable cover is provided for an optical sensor and comprises a transparent cover element, a transparent and electrically conductive coating that is arranged at the cover element, and at least two electrodes that are spaced apart from one another and that are each in contact with the coating. A respective distance between a respective two of the electrodes is defined along a respective distance line across the coating. Each of the at least two electrodes further has at least one contacting position at which the respective electrode is connected to a voltage source. The contacting positions of a respective two electrodes are spaced apart from one another in a direction that extends at a right angle to the distance line.

The heatable cover is characterized, on the one hand, in that a transparent coating is provided that is heated due to its electrical conductivity when a voltage is applied between the at least two electrodes. The coating can extend over the largest part of the heatable cover with respect to its surface so that a large-area heating of the cover is made possible. Due to the transparency of the coating, the area of the optical opening for the sensor is not restricted by the coating. This enables the use of the cover with scanning optical sensors.

The distance line is an imaginary line between the electrodes across the coating. A minimum distance between the electrodes can be defined along the distance line. Since the electrodes are spaced apart from one another along the distance line, the coating thus extends substantially between the electrodes, i.e. apart from minor marginal regions that lie outside the electrodes.

Since the contacting positions of two mutually different electrodes are arranged at the spaced-apart electrodes, on the one hand, and are spaced apart in the direction perpendicular to the distance line between the electrodes, on the other hand, the respective contacting positions of two mutually different electrodes are thus arranged spaced apart or offset from one another in two directions that extend at right angles to one another. In other words, the contacting positions of each of the electrodes are spaced apart or offset from one another in two mutually orthogonal directions in relation to the contacting positions of the further electrodes.

Due to the offset arrangement of the contacting positions, an electric field with an increased homogeneity can be generated between the electrodes, that is, parallel to the distance line, i.e. compared to electrodes having contacting positions that are not offset perpendicular to the distance line. With mutually oppositely disposed electrodes, similar potential differences can thereby, for example, be present between points that are arranged at opposite sides of the distance line at two different electrodes. Consequently, a relatively homogeneous electric field can be generated between the electrodes across the conductive coating. If the conductivity of the coating is largely homogeneous across its surface, a high homogeneity of the electric field across the coating leads to a homogeneous heating of the cover when the coating is supplied with energy or heating power via the electrodes.

The transparent and electrically conductive coating can further be arranged at an inner surface of the cover element. The coating is protected against influences from the environment of the optical sensor by this arrangement. The service life of the coating and the optical sensor can thereby be extended.

The electrodes can furthermore be elongate and extend along a respective margin of the coating. The electric field between the electrodes can thereby cover almost the entire surface of the coating. This can further improve the homogeneity of the heating of the cover.

According to one embodiment, two electrodes can be arranged at mutually oppositely disposed sides (margins) of the transparent and electrically conductive coating. The homogeneous heating of the coating and the cover can be further improved overall by this arrangement of the electrodes at oppositely disposed sides (margins) of the coating. Furthermore, the electrodes can extend parallel to one another, whereby the homogeneity of the electric field and of the heating of the cover can be further increased.

Furthermore, the two electrodes can be superposed on mutually oppositely disposed margins of the coating. In other words, the margins of the cover can be completely covered by the electrodes. The electric field between the electrodes can thereby act over the entire surface of the coating, whereby the homogeneity of the heating across the coating can be further increased.

According to a further embodiment, each of the at least two electrodes can have a plurality of contacting positions, wherein a number of the contacting positions for each of the at least two electrodes can be defined based on a ratio of an electrical resistance of the conductive coating and a total electrical resistance of the two electrodes.

The electrical resistance of the coating is in particular greater than the total electrical resistance of the at least two electrodes. The ratio of the electrical resistance of the conductive coating and the total electrical resistance of the two electrodes is preferably greater than 5.

It has been shown that the electrical resistance of the electrodes cannot necessarily be regarded as negligible (for example in the case of plastic covers) if a homogeneous electric field between them, and thus a homogeneous heating of the conductive coating, are to be achieved. The homogeneity of the heating can be increased by minimizing the electrical resistance of the electrodes compared to the resistance of the conductive coating.

The electric field between the electrodes can additionally be improved in terms of its homogeneity by increasing the number of the contacting positions for each of the at least two electrodes. The greater the total electrical resistance of the electrodes is, i.e. the smaller the ratio of the electrical resistance of the conductive coating to the total resistance of the electrodes is, the greater the number of contacting positions per electrode should be. Conversely, the number of the contacting positions can be reduced by minimizing the total electrical resistance of the electrodes.

To achieve a homogeneous heating by means of the conductive coating, its electrical resistance should be at least 5 times greater than the total resistance of the electrodes, as already mentioned. It may then be possible that a single contacting position per electrode is sufficient, but this depends on the desired heating power and the electrical resistance of the conductive coating.

According to a further embodiment, the cover element can have a cylindrical shape with a lateral surface and two electrodes can be peripherally arranged in parallel at an inner side of the lateral surface. In contrast to an axial arrangement of the two electrodes, i.e. a lateral arrangement of the electrodes along the lateral surface, electrodes peripherally arranged in parallel can minimize the electrical resistance of the conductive coating. The heating power that can be achieved by means of the conductive coating can thereby be maximized for a predefined voltage between the electrodes.

Advantageously, the at least two electrodes can be arranged in respective marginal regions of the lateral surface. The surface of the coating between the two electrodes, and thus the heatable surface, can thereby be maximized. In the case of an optical sensor that performs a scanning function in the azimuthal direction, i.e. peripherally over the lateral surface of the cylindrical cover element, the parallel peripheral arrangement of the electrodes can further provide a larger azimuthal field of view than, for example, an arrangement of the electrodes in the axial direction.

In a further embodiment, the cover element can be formed as a truncated cone and two electrodes can be peripherally arranged with a constant distance at the inner side of the truncated cone. The advantages of the above-described embodiment with a cylindrical cover element also apply accordingly to this embodiment with a frustoconical cover element since ultimately only the lateral surface of the cylinder is replaced by a slanted surface. The slanted surface can be formed, for example, by a draft angle if the cover element is manufactured using an injection molding process.

According to a further embodiment, the cover element can have a planar shape, and two electrodes can be arranged at mutually oppositely disposed margins of the planar shape. A planar cover can be produced in a simpler way than a cylindrical or frustoconical cover, for example. Furthermore, the conductive coating can also be applied in a simpler way. The contacting positions can thereby be more easily accessible than, for example, with a cylindrical cover. A planar cover can, for example, be provided as a front screen for a correspondingly configured static optical sensor.

The invention will be described below by way of example with reference to advantageous embodiments and to the enclosed Figures. There are shown, schematically in each case:

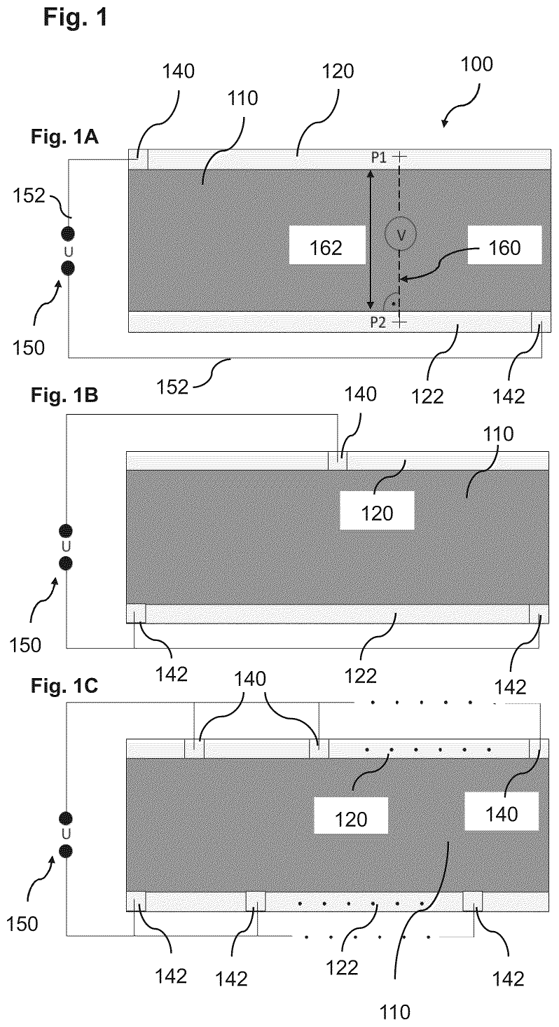

FIGS. 1A, 1B, 1C plan views of embodiments for a cover for an optical sensor;

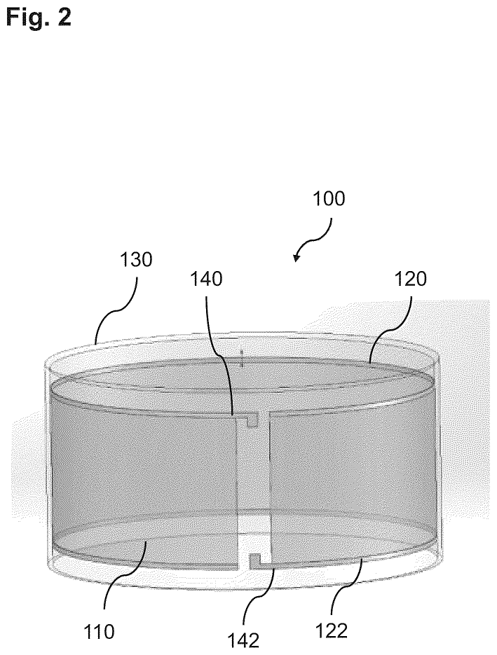

FIG. 2 a perspective view of a cover for an optical sensor; and

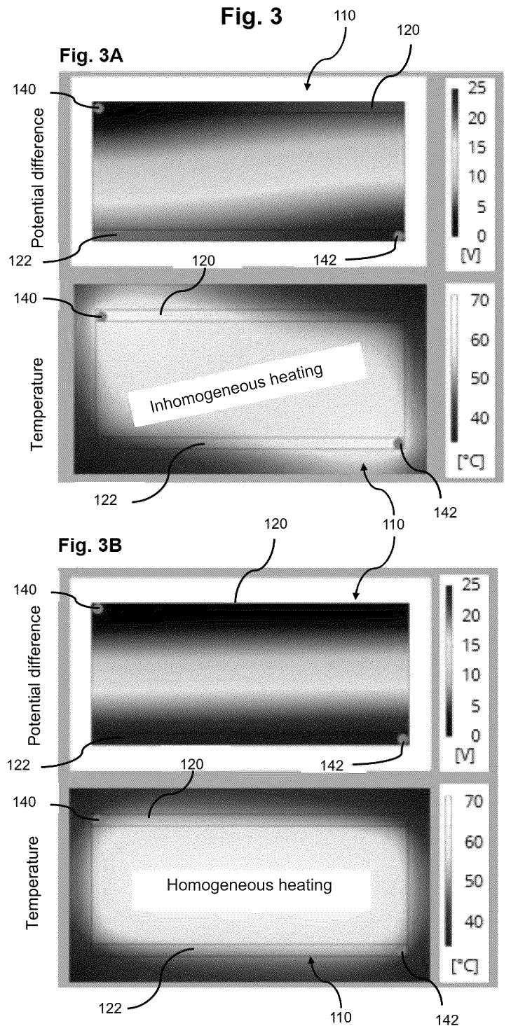

FIGS. 3A and 3B results of simulations of the heating of a cover for an optical sensor.

FIGS. 1A, 1B, 1C show schematic plan views of embodiments of a heatable cover 100 for an optical sensor. The cover 100 comprises a transparent cover element that is concealed in the plan views of FIGS. 1A, 1B, 1C and is therefore not shown. In the present embodiments, the transparent cover element is a planar front screen of the optical sensor.

A transparent and electrically conductive coating 110 is arranged at the transparent cover element. Such a coating 110 comprises, for example, a flexible film coated with a TCF (transparent conductive film), wherein the TCF has carbon nanotubes, for example. Furthermore, silver nanowires can be embedded in an ink with carbon nanotubes and applied to a flexible film. The coated flexible film is subsequently applied to the inner side of the cover element as the transparent and electrically conductive coating 110.

A respective electrode 120, 122 is attached to respective margins at oppositely disposed sides of the transparent and electrically conductive coating 110. One electrode 120 is superposed on an upper margin of the coating 110, while another electrode 122 is superposed on a lower margin of the coating 110. The electrodes 120, 122 extend parallel to one another and are formed as elongate such that they completely cover the respective margins of the transparent and electrically conductive coating 110. The electrodes 120, 122, for example, consist of gold or silver and are applied to the coating 110 by means of PVD (physical vapor deposition).

In the further embodiment of the heatable cover 100 shown in FIG. 2, it comprises a transparent cover element 130 that is cylindrical. The transparent and electrically conductive coating 110 is again applied to the inner side of the transparent cover element 130. Furthermore, the electrode 120 is arranged at the upper side of the coating 110, whereas the electrode 122 is arranged at the lower side of the coating 110. Just as in the planar embodiment example of the cover element and the coating 110 of FIG. 1, in the embodiment of the cover 100 with a cylindrical cover element 130 shown in FIG. 2, the electrodes 120, 122 extend parallel to one another and are completely superposed on the upper or lower margin of the coating 110.

In the embodiment example of FIG. 2, the electrodes 120, 122 are peripherally arranged at the respective margins of the coating 110, i.e. peripherally around a cylinder axis, not shown, of the cylindrical cover element 130. The planar embodiment of the cover 100 shown in FIG. 1A can thus also be viewed as a schematic, unrolled representation of the inner side of the transparent cover element 130 for the embodiment of the cover 100 of FIG. 2. Conversely, in the embodiment of the cover 100 of FIG. 2, the planar coating 110 with the electrodes 120, 122 of FIG. 1A is applied to the inner side of the cylindrical cover element 130. The following statements regarding the planar embodiments of the transparent cover element, which are shown in FIGS. 1A, 1B and 1C, consequently also analogously apply to the embodiment of the cover 100 of FIG. 2 with a cylindrical cover element 130.

In the embodiment of FIG. 1A, the electrodes 120, 122 each have a contacting position 140 or 142 via which the respective electrode 120, 122 is connected to a voltage source 150. The electrodes 120, 122 are connected to the voltage source 150 via the contacting positions 140, 142 by means of electrical lines 152.

In the embodiment of FIG. 1A, each of the electrodes 120, 122 in each case has only one contacting position 140 and 142 that are arranged at opposite ends of the electrodes 120, 122 in each case. In the embodiment of FIG. 1B, however, the electrode 120 has a central contacting position 140, while the further electrode 122 has two contacting positions 142 at respective ends of the electrode 122. The further embodiment of the cover 100 shown in FIG. 1C further has a plurality of respective contacting positions 140,142 at both the electrode 120 and the electrode 122.

The three embodiments of FIGS. 1A, 1B and 1C have in common that the contacting positions 140 of the electrode 120 are arranged offset with respect to the contacting positions 142 of the further electrode 122. If a distance line 160 between the electrodes 120, 122 defines their minimum distance, the offset arrangement of the contacting positions 140, 142 relative to one another means that they are spaced apart from one another in a direction that extends at a right angle to the distance line 160. However, in the embodiments of FIGS. 1A, 1B, 1C and 2, the distance 162 between the electrodes 120, 122 is constant so that the distance line 160 can be arranged at any desired position along the electrodes 120, 122 in a direction perpendicular thereto.

Since the transparent and electrically conductive coating 110 is arranged between the electrodes 120, 122, an electric field is formed over the coating 110 as soon as the electrodes 120, 122 are connected to the voltage source 150. The spacing apart of the contacting positions 140, 142 in the direction perpendicular to the distance line 160 causes similar or almost identical potential differences or electric field strengths to be present between any two points P1 and P2 that are arranged at opposite sides of the coating 110 and the distance line 160 at a respective one of the electrodes 120, 122 if the electrodes 120, 122 are connected to the voltage source via the contacting points 140, 142.

In other words, a similar or almost identical potential difference occurs between respective points P1, P2 at both sides of the conductive coating 110 if they have the same distance from one another. A similar or almost identical potential difference thus occurs along the electrodes 120, 122 for such pairs of points P1, P2.

Due to the almost homogeneous electric field between the two electrodes 120, 122, an almost homogeneous heating occurs in the coating 110 within the transparent and electrically conductive coating 110 since a current flows through the coating 110 due to the electrical resistance of the coating 110 as soon as the electrodes 120, 122 are connected to the voltage source 150. Naturally, this only applies if the coating 110 also has an almost homogeneous electrical resistance across its surface.

The width of the electrodes 120, 122 is shown greatly enlarged in the representations of FIGS. 1A, 1B, 1C and 2 for the sake of clarity. In the actual design of the cover 100, the electrodes 120, 122 have a width in the direction of the distance line 160 that is very small compared to the distance 162 of the electrodes 120, 122. Due to the small width of the electrodes 120, 122, the electrical resistance of the electrodes 120, 122 is not negligible compared to the electrical resistance of the coating 110 or to the total resistance to which the voltage of the voltage source 150 is applied. As will be explained in more detail below in connection with FIGS. 3A and 3B, a relatively high resistance of the electrodes 120, 122 compared to the resistance of the coating 110 can lead to an inhomogeneity of the electric field and of the heating across the coating 110.

The homogeneity of the electric field between the electrodes 120, 122, i.e. across the coating 110, can be increased by increasing the number of the contacting points 140, 142 at the respective electrodes 120, 122, as illustrated for the embodiments of FIGS. 1B and 1C. However, for a desired field homogeneity, the number of the contacting points 140, 142 can be minimized by arranging the contacting points 140 at the one electrode 120 offset with respect to the contacting points 142 at the other electrode 122 in the direction at a right angle to the connecting line 160. The number of necessary contacting points for a predefined field homogeneity is defined by the ratio of the electrical resistance of the conductive coating 110 to the total electrical resistance of the electrodes 120, 122.

As already explained above, in the embodiment of the heatable cover with a cylindrical cover element 130 shown in FIG. 2, the electrodes 120, 122 are peripherally arranged in parallel at respective margins of the coating 110. For a given sheet resistance Rₛₕₑₑₜ of the coating 110, the total resistance that is relevant for the heating power is given by the product of the sheet resistance Rₛₕₑₑₜ of the coating 110 and the ratio of the height h and periphery 2πR of the cylindrical cover element 130, where R is the cylinder radius:

R_{B}=Rₛₕₑₑₜ×h/(2πR)

In the embodiment example of FIG. 2, the height h of the cover element 130 approximately corresponds to the axial length over which the coating 110 extends and to the distance 162 (cf. FIGS. 1A, 1B, 1C) of the electrodes 120, 122 parallel to the cylinder axis of the cover element 130. In other words, the lateral surface of the cylindrical cover 100 of FIG. 2 is almost completely covered by the coating 110. The periphery 2πR of the cover element 130 approximately corresponds to the length of the electrodes 120, 122.

The sheet resistance for a conductive coating 110 that, for example, comprises an above-described TCF is approximately 50 to 100 ohms. With an exemplary sheet resistance of 100 ohms and a ratio of height h to periphery 2πR of 0.085 for a cylindrical cover of an exemplary scanning optical sensor, a total resistance R_{B} of approximately 8.5 ohms results. The heating power across the coating 110 with the resistance R_{B} is given by P=UI=U²/R_{B} when a voltage U is applied to the coating. Thus, at a voltage of 20 V that is applied to the electrodes 120, 122, the heating power amounts to approximately 47 W for the exemplary coating 110 that has a resistance of 8.5 ohms and that is applied to a lateral surface of a cylindrical cover.

If the electrodes 120, 122 were arranged in the axial direction, i.e. parallel to the cylinder axis of the cover element 130 at the margins of the coating 110 that extend in the axial direction, the total resistance would be given by the inverse ratio of the periphery 2πR to the height h of the cover 100 multiplied by the sheet resistance R_{Sheet}. With the above-described exemplary cylindrical cover, due to the small ratio of 0.085 of the height h to the periphery 2πR, a value of approximately 12 would result for the inverse ratio of the periphery 2πR to the height h. This would lead to a considerably greater total resistance of approximately 1200 ohms with a sheet resistance R_{Sheet} of 100 ohms and the heating power would, with the same applied voltage, be smaller by about a factor of 20 than with the peripheral arrangement of the electrodes 120, 122, as is shown in FIG. 2. Compared to the axial arrangement of the electrodes 120, 122, the embodiment with parallel peripheral electrodes 120, 122 thus provides a considerably greater heating power across the coating 110.

FIGS. 3A and 3B show results of an exemplary thermal simulation that was performed for a coating 110 on a planar cover element, as shown in FIG. 1A, for example. The distribution of the potential difference in V across the coating 110 is shown in the respective upper diagram of FIGS. 3A and 3B, wherein the electrodes 120, 122 are arranged at the upper or lower margin of the coating 110. In the lower diagram of FIGS. 3A and 3B, the temperature distribution across the coating 110 is shown, wherein the electrodes 120, 122 are likewise arranged at the upper or lower margin of the coating 110. Furthermore, a respective contacting point 140 or 142 is arranged at each of the electrodes 120, 122.

For the simulation of FIG. 3A, a relatively large total resistance of the electrodes 120, 122 was assumed, i.e. a total resistance of the electrodes in the same order of magnitude as the electrical resistance of the coating 110. Specifically, it was assumed for the simulation of FIG. 3A that the ratio of the resistance of the coating 110 to the total resistance of the electrodes 120, 122 is small compared to 5.

However, for the simulation of FIG. 3B, a smaller total resistance of the electrodes 120, 122 was assumed, i.e. a total resistance of the electrodes 120, 122 that is considerably smaller than the electrical resistance of the coating 110. In detail, it was assumed for the simulation of FIG. 3B that the ratio of the resistance of the coating 110 to the total resistance of the electrodes 120, 122 is large compared to 5.

On the right-hand side next to the respective diagrams of the potential difference and the temperature, values of the potential difference and the temperature across the coating are specified that are associated with the respective gray scales in the diagrams of FIGS. 3A and 3B. In the respective upper diagrams, a potential difference of 0 V is in each case present at the lower electrode 122, while a potential difference of 25 V is present at the upper electrode. In the respective lower diagrams, the one lighter shade is in each case associated with a higher temperature of up to 70 degrees Celsius.

It can be seen that in the upper diagram of FIG. 3A, in which a relatively high resistance of the electrodes 120, 122 was assumed, there is an uneven potential distribution between the electrodes, above all along the upper and lower side of the coating 110. This leads to an inhomogeneous heating of the coating 110, as can be seen from the lighter and darker shading in the lower diagram of FIG. 3A.

As can be seen in the upper diagrams of FIG. 3B compared to the upper diagram of FIG. 3A, a low resistance of the electrodes 120, 122 compared to the resistance of the coating 110 leads to a considerably more homogeneous voltage distribution over the coating 110. This causes a considerably more homogeneous temperature distribution or heating over the coating 110, as can be seen in the lower diagram of FIG. 3B. The corresponding cover element 130, which is in contact with the coating 110 and is shown, for example, in FIG. 2, is thereby also heated more homogeneously than in the embodiment of FIG. 3A with a higher resistance of the electrodes 120, 122.

In summary, a homogeneous electric field across the coating 110 and thus a homogeneous heating can be achieved, on the one hand, by arranging the contacting positions 140, 142 offset from one another at the electrodes 120, 122, as is shown in FIGS. 1A, 1B, 1C. As can be seen from FIGS. 3A and 3B, the homogeneity of the electric field, and thus the heating of the cover 100, can be additionally increased by matching the electrical resistance of the electrodes 120, 122 with the electrical resistance of the coating 110 such that the resistance of the electrodes 120, 122 is significantly smaller than the resistance across the coating 110.

Although the invention is not limited to this, it is particularly suitable for cover elements composed of plastic since the described homogenizing effect of the arrangement according to the invention is particularly advantageous here due to the poorer thermal conductivity or higher thermal expansion of plastic compared to glass.

### REFERENCE NUMERAL LIST

100 heatable cover for an optical sensor
110 transparent and electrically conductive coating
120 electrode
122 electrode
130 transparent cover element
140 contacting position
142 contacting position
150 voltage source
152 electrical line
160 distance line
162 distance between the electrodes

1-10. (canceled)

11. A heatable cover for an optical sensor, said heatable cover comprising:
a transparent cover element,
a transparent and electrically conductive coating that is arranged at the cover element, and
at least two electrodes that are spaced apart from one another and that are each in contact with the coating, wherein a respective distance between a respective two of the electrodes is defined along a respective distance line across the coating (110),
wherein each of the at least two electrodes has at least one contacting position at which the respective electrode is connected to a voltage source, and
wherein the contacting positions of a respective two electrodes are spaced apart from one another in a direction that extends at a right angle to the distance line.

12. The heatable cover according to claim 11,
wherein the electrodes are elongate and extend along a respective margin of the coating.

13. The heatable cover according to claim 11,
wherein two electrodes are arranged at mutually oppositely disposed sides of the coating.

14. The heatable cover according to claim 13,
wherein the two electrodes are superposed on mutually oppositely disposed margins of the coating.

15. The heatable cover according to claim 11,
wherein
each of the at least two electrodes has a plurality of contacting positions, and
a number of the contacting positions for each of the at least two electrodes is defined based on a ratio of an electrical resistance of the conductive coating and a total electrical resistance of the at least two electrodes.

16. The heatable cover according to claim 15,
wherein the electrical resistance of the coating is greater than the total electrical resistance of the at least two electrodes.

17. The heatable cover according to claim 15,
wherein the ratio of the electrical resistance of the conductive coating and the total electrical resistance of the at least two electrodes is greater than five.

18. The heatable cover according to claim 11,
wherein
the cover element has a cylindrical shape with a lateral surface and
two electrodes are peripherally arranged in parallel at an inner side of the lateral surface.

19. The heatable cover according to claim 11,
wherein
the cover element is formed as a truncated cone and
two electrodes are peripherally arranged with a constant distance at the inner side of the truncated cone.

20. The heatable cover according to claim 11,
wherein
the cover element has a planar shape and
two electrodes are arranged at mutually oppositely disposed margins of the planar shape.
